(19) United States
(12) Patent Application Publication
(10) Pub. No.: US 2003/0190164 A1
(43) Pub. Date: Oct. 9, 2003

(54) Camera

(75) Inventors: Haruo Onozuka, Saitama-shi (JP); Makoto Akiba, Saitama-shi (JP)

Correspondence Address: LEYDIG VOIT & MAYER, LTD, 700 THIRTEENTH ST. NW, SUITE 300, WASHINGTON, DC, 20005-3960, US

(73) Assignee: Fuji Photo Optical Co., Ltd., Saitama-shi (JP)

(21) Appl. No.: 10/396,833

(22) Filed: Mar. 26, 2003

(30) Foreign Application Priority Data
Apr. 9, 2002 (JP) 2002-107004

(51) Int. Cl. G03B 7/26

(52) U.S. Cl. 396/279

(57) ABSTRACT

A camera 1 comprises an electric circuit section including a date circuit 10b for determining a shooting date and time, a main battery 38 for supplying power to the electric circuit section, an auxiliary battery 37 for supplying power to the date circuit 10b when the power supply from the main battery 38 to the electric circuit section stops, a battery check circuit 28 for measuring a voltage of the auxiliary battery 37, a main controller 10a for determining according to thus measured voltage whether replacement of the auxiliary battery 37 is necessary or not, and an LCD 18 for displaying information for urging the auxiliary battery 37 to be replaced according to the result of determination.

### BACKGROUND OF THE INVENTION

1. Field of the Invention

The present invention relates to a camera having clock means for determining the date and time at which a picture is taken.

2. Related Background Art

Cameras having a so-called date function by which shooting dates and times are imprinted onto a film have been known. A camera having the date function comprises a date imprinting section for imprinting a shooting date and time, and a clock circuit section acting as clock means for determining the date and time. Though the clock circuit section is usually supplied with power from a main battery, the power supply from the main battery temporarily stops when replacing the main battery, whereby the clock function of the clock circuit stops. When the clock function of the clock circuit section stops, the date and time determined by the clock circuit section is initialized, thus deviating from the actual date and time. For eliminating this deviation, it is necessary for a camera user to correct the date and time setting in the clock circuit section, which may be a troublesome operation.

Hence proposed are cameras in which an auxiliary battery supplies power when the main battery is taken out for replacement and the like as disclosed in Japanese Patent Application Laid-Open Nos. HEI 7-28159 and HEI 8-286258.

### SUMMARY OF THE INVENTION

The auxiliary battery has a capacity smaller than that of the main battery, and thus cannot supply power for a very long time. Therefore, if the main battery is replaced a number of times or it takes a long time for replacing the main battery, the electric capacity of the auxiliary battery may be used up, thus failing to supply power when necessary.

Hence, it is an object of the present invention to provide a camera which can supply power from an auxiliary battery more reliably when no power is supplied from a main battery.

The present invention provides a camera comprising an electric circuit section including clock means for determining a shooting date and time; a main battery for supplying power to the electric circuit section; an auxiliary battery for supplying power to the clock means when the power supply from the main battery to the electric circuit section stops; voltage measuring means for measuring a voltage of the auxiliary battery; replacement determining means for determining according to the measured voltage whether replacement of the auxiliary battery is necessary or not; and display means for displaying information for urging the auxiliary battery to be replaced according to a result of the determination.

The camera in accordance with the present invention determines whether replacement of the auxiliary battery is necessary or not according to the result of measurement of the voltage thereof, and thus can prevent the voltage supplied from the auxiliary battery from being left in the lowered state, whereby the auxiliary battery can respond to a case where it is required to supply power in place of the main battery. According to the result of determination, information urging the auxiliary battery to be replaced is displayed, so that the user can grasp the state of the auxiliary battery and replace it appropriately.

The camera in accordance with the present invention may further comprise a switch for inputting a predetermined instruction signal to the electric circuit section, whereas, in response to an operation of the switch, the voltage measuring means may measure the voltage of the auxiliary battery, the replacement determining means may determine whether replacement of the battery is necessary or not, and the display means may display the information. In response to various switch operations effected by the user, the voltage measuring means, replacement determining means, and display means can carry out predetermined operations, so as to determine whether replacement of the auxiliary battery is necessary or not, and transmit predetermined information to the user, whereby the state of the auxiliary battery can be grasped more appropriately.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention may be more readily described with reference to the accompanying drawings, in which:

FIG. 1 is a block diagram of a camera in accordance with an embodiment of the present invention;

FIG. 2 is a circuit diagram of the camera in accordance with the above-mentioned embodiment;

FIG. 3 is a flowchart showing operations of the camera in accordance with the above-mentioned embodiment;

FIG. 4A is a view showing an LCD screen shot of the camera in accordance with the above-mentioned embodiment; and

FIG. 4B is a view showing an LCD screen shot of the camera in accordance with the above-mentioned embodiment.

### DESCRIPTION OF THE PREFERRED EMBODIMENTS

The findings of the present invention can easily be understood in view of the detailed description hereinbelow with reference to the accompanying drawings given by way of illustration only. An embodiment of the present invention will now be explained with reference to the accompanying drawings. Parts identical to each other will be referred to with numerals identical to each other whenever possible, so as to omit their overlapping explanations.

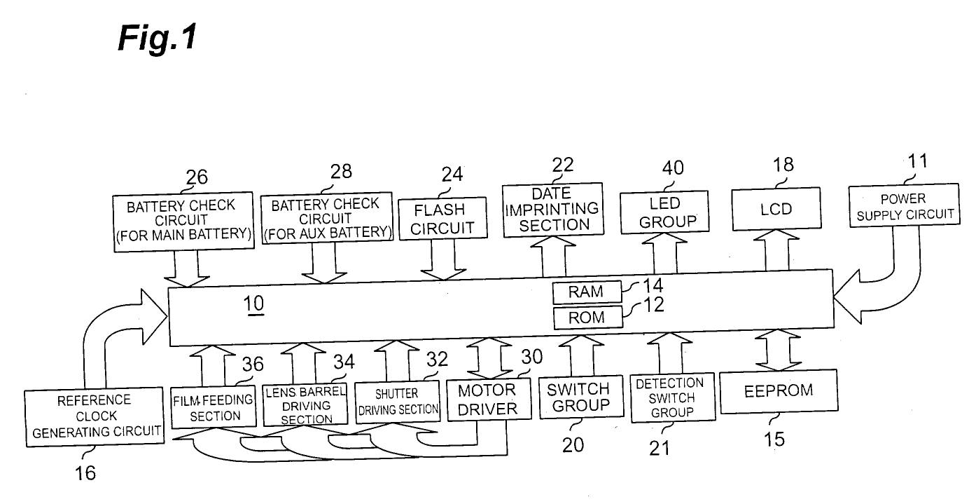

With reference to FIG. 1, a camera 1 in accordance with an embodiment of the present invention will be explained. FIG. 1 is a block diagram of the camera 1. The camera 1 is provided with a CPU (including an electric circuit section, clock means, and replacement determining means) 10. The CPU 10 functions as a main controller for controlling the camera 1 as a whole and receives power from a power supply circuit 11. Also, the CPU 10 incorporates therein a ROM 12 having stored a program for control/arithmetic operations beforehand and a RAM 14 for storing various kinds of data at the time of control/arithmetic operations. Further connected to the CPU 10 is an EEPROM 15 for storing the state of the camera, various control parameters, and the like at each point of time.

A reference clock generating circuit 16 generates a clock to become a reference, and is constituted, for example, by a crystal oscillator or the like. According to this reference clock, the CPU 10 counts up seconds, minutes, hours, days, months, and years. Namely, the CPU 10 also includes a date circuit (clock means) functioning as clock means for counting time in conformity to the reference clock.

Information concerning the date and time thus counted up is displayed on an LCD (display means) 18 or the like. The LCD 18 displays not only the information concerning date and time, but also information necessary for shooting and information concerning the state of power supply.

A switch group 20 is constituted by a shutter button for releasing a shutter, a mode switch for setting modes of shooting, a self-timer switch for shooting with a is self-timer, a main switch for switching the camera 1 between a ready-to-shoot state and a shooting-inhibited state, a zoom switch. (TELE/WIDE switch) for zooming, an open/close switch for opening/closing a cartridge lid, an MR switch for ordering a film to be rewound in the middle, a cartridge presence switch for verifying whether the camera is loaded with a film cartridge or not, and the like.

A detection switch group 21 includes a lid open/close switch for detecting whether the battery lid of a battery compartment storing the main battery therein is opened or closed, and a battery detecting switch for detecting whether the main battery is actually removed or not.

A date imprinting section 22 is used for imprinting the displayed time when the camera 1 captures an image of an object. A flash circuit 24 has a light-emitting member disposed within a flash window, and flashes the light-emitting member in conformity to a chosen shooting mode (mode concerning a flashing scheme or the like) under the control of the CPU 10.

A motor driver 30 receives a control signal from the CPU 10 and outputs a driving signal to a shutter driving section 32, a lens barrel driving section 34, and a film feeding section 36. In response to this driving signal, the shutter driving section 32 drives the shutter, the lens barrel driving section 34 drives the lens barrel to expand and collapse, and the film feeding section 36 feeds the film of the loaded film cartridge forward or backward.

A battery check circuit 26 for the main battery is a circuit for checking the state of the main battery. A battery check circuit (voltage measuring means) 28 for the auxiliary battery is a circuit for checking the state of the auxiliary battery. The battery check circuit 26 for the main battery and the battery check circuit 28 for the auxiliary battery are configured so as to be able to acquire voltage values of the main and auxiliary batteries, respectively.

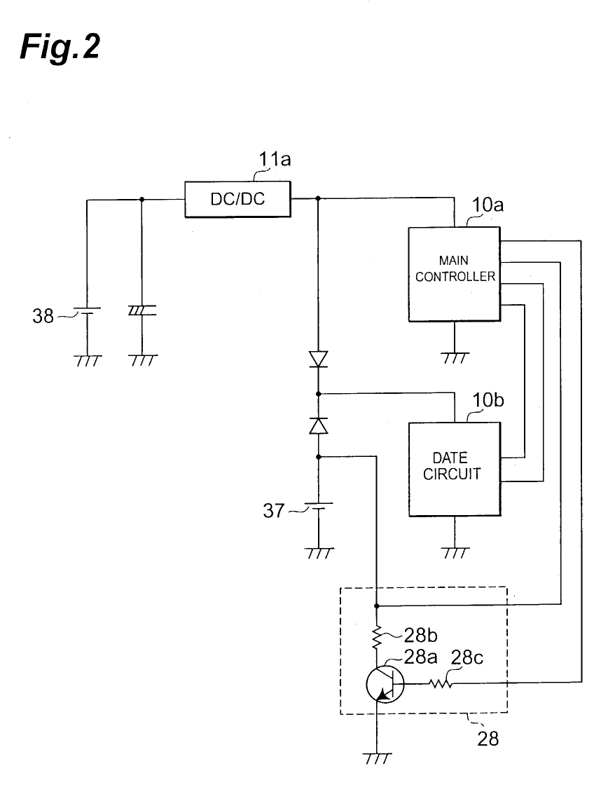

With reference to FIG. 2, the battery check circuit 28 for the auxiliary battery in the camera 1 in accordance with the embodiment of the present invention will now be explained. FIG. 2 is a diagram showing the circuit configuration of a part related to the battery check circuit 28. A main controller 10a and a date circuit 10b which are included in the CPU 10 are supplied with power from a main battery 38 by way of a DC/DC converter 11a included in the power supply circuit 11. They are configured such that power is supplied from the auxiliary battery 37 to the date circuit 10b when the power supply from the main battery 38 stops.

The battery check circuit 28 is disposed between the auxiliary battery 37 and the date circuit 10b. The battery check circuit 28 is constituted by a transistor 28a and a resistor 28b which are connected in series, and a resistor 28c. The battery check circuit 28 outputs the voltage of the auxiliary battery 37 to the main controller 10a. According to this output, the main controller 10a carries out A/D conversion by using an A/D converter included therein, thereby acquiring the voltage of the auxiliary battery 37.

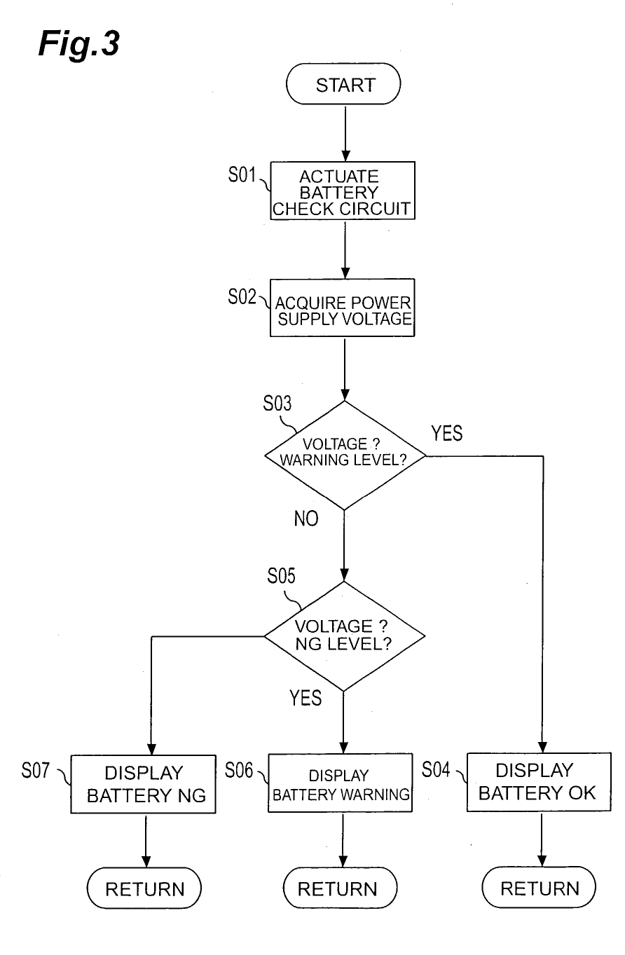

By using FIG. 3, a flow for providing a display urging the auxiliary battery 37 to be replaced will now be explained while referring to FIG. 2 when appropriate. The main controller 10a outputs an actuation signal to the battery check circuit 28 for the auxiliary battery at a predetermined timing, whereby the battery check circuit 28 is actuated in response to the actuation signal (step S01). Here, the predetermined timing may be the same as a timing at which individual parts of the camera 1 operate, a timing at predetermined intervals during the waiting state of the camera 1, a timing at which the main switch is turned ON for making the camera 1 ready to shoot, a timing at which the main switch is turned OFF after shooting, or a timing at which various kinds of other switches operable by a user such as a mode changeover switch and a zoom switch are operated.

The battery check circuit 28 outputs the voltage of the auxiliary battery 37 to the main controller 10a. According to this output, the main controller 10a carries out A/D conversion by using an A/D converter included therein, thereby acquiring the voltage of the auxiliary battery 37 (step S02). Upon acquiring the voltage value of the auxiliary battery 37, the main controller 10a determines whether the voltage value reaches a predetermined warning level or not (step S03). If the value is at the warning level or higher according to the result of determination, an instruction signal indicative of the fact that the auxiliary battery 37 is in a favorable state is outputted to the LCD 18. In response to this instruction signal, the LCD 18 provides a display (step S04). In this case, the LCD 18 may provide no display in particular.

If the voltage value of the auxiliary battery 37 is lower than the warning level at step S04, the main controller 10a determines whether the voltage value reaches a predetermined danger level or not (step S05). If the value is at the danger level or higher according to the result of determination, an instruction signal for providing a warning display indicative of the fact that the voltage value of the auxiliary battery 37 is lowered is outputted to the LCD 18. According to the instruction signal, the LCD 18 provides the warning display (step S06).

If the voltage value is lower than the danger level according to the result of determination at step S05, an instruction signal for providing a danger display indicative of the fact that the voltage value of the auxiliary battery 37 is lowered to a dangerous state is outputted to the LCD 18. According to the instruction signal, the LCD 18 provides the warning display (step S07).

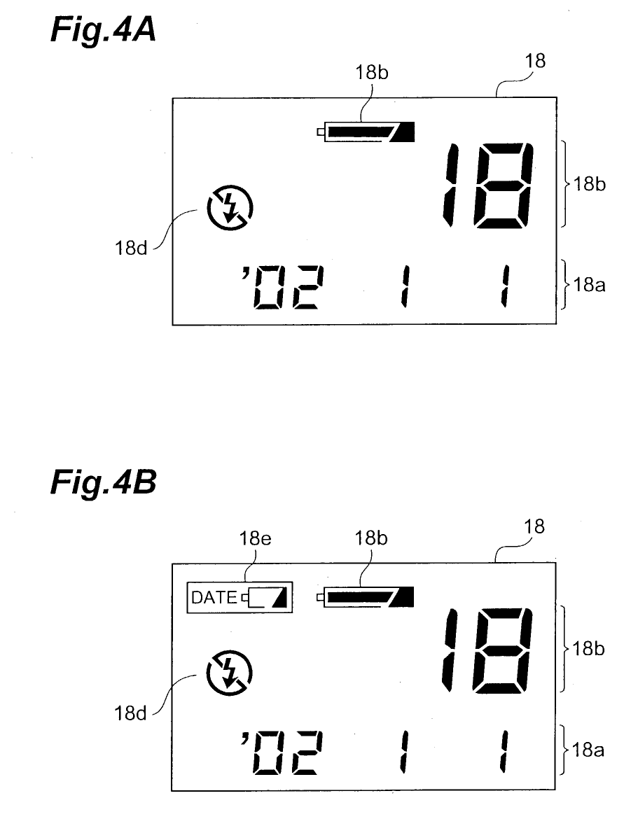

The warning display and danger display provided by the LCD 18 will now be explained with reference to FIGS. 4A and 4B. FIG. 4A is a view showing a normal state of the LCD 18, whereas FIG. 4B is a view showing a state of warning display or danger display. In the normal state, as shown in FIG. 4A, the LCD 18 shows information items such as a date indicator 18a, a picture number indicator 18b, a main power supply state indicator 18c, and a flash indicator 18d. When an instruction signal for providing a warning display is inputted from the main controller 10a, on the other hand, an auxiliary battery alarm indicator 18e shown in FIG. 4B is lit. When an instruction signal for providing a danger display is inputted from the main controller lob, the auxiliary battery alarm indicator 18e is blinked. In the case of warning display or danger display, the main battery state indicator 18c and the date indicator 18a may be blinked together.

Since it is determined according to the result of measurement of the voltage of the auxiliary battery 37 whether replacement of the auxiliary battery 37 is necessary or not, this embodiment can prevent the voltage supplied from the auxiliary battery 37 from being left in the lowered state, whereby the auxiliary battery 37 can respond to the case where it is required to supply power in place of the main battery 38. Also, information for urging the auxiliary battery 37 to be replaced is displayed according to the result of determination, whereby the user can grasp the state of the auxiliary battery 37 and appropriately replace the auxiliary battery 37. The present invention is applicable to various kinds of cameras without being restricted to silver halide cameras, digital cameras, and video cameras.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A camera comprising:
an electric circuit section including clock means for determining a shooting date and time;
a main battery for supplying power to said electric circuit section;
an auxiliary battery for supplying power to said clock means when said power supply from said main battery to said electric circuit section stops;
voltage measuring means for measuring a voltage of said auxiliary battery;
replacement determining means for determining according to said measured voltage whether replacement of said auxiliary battery is necessary or not; and
display means for displaying information for urging said auxiliary battery to be replaced according to a result of said determination.

2. The camera according to claim 1, further comprising a switch for inputting a predetermined instruction signal to said electric circuit section;
wherein, in response to an operation of said switch, said voltage measuring means measures said voltage of said auxiliary battery, said replacement determining means determines whether replacement of said auxiliary battery is necessary or not, and said display means displays said information.
